(19) United States
(12) Patent Application Publication
(10) Pub. No.: US 2017/0064082 A1
(43) Pub. Date: Mar. 2, 2017

(54) PARTIAL TASK ASSIGNMENT FOR STALL ROUTING

(71) Applicant: Avaya Inc., Santa Clara, CA (US)

(72) Inventors: Valentine C. Matula, Granville, OH (US); George Erhart, Loveland, CO (US); David Skiba, Golden, CO (US)

(21) Appl. No.: 14/834,759

(22) Filed: Aug. 25, 2015

(51) Int. Cl. H04M 3/523; H04M 3/51

(52) U.S. Cl. CPC H04M 3/5233; H04M 3/5238; H04M 3/5175; H04M 3/5191

(57) ABSTRACT

Contact centers strive to provide quality customer service in a timely manner as well as to maintain profitability to ensure continued business operations. Having optimal agents available to accept every work item a customer may have is expensive and, when such skills are unneeded, wasteful. Once a work item is received, an optimal agent or agents are identified; however, if the wait time is unacceptable, the work item may be passed to a suboptimal agent who is able to process a portion of the work item. Once the optimal agent becomes available, the work item is joined by the optimal agent or, alternatively, a second non-optimal agent is brought in to address a second portion of the work item.

### FIELD OF THE DISCLOSURE

The present disclosure is generally directed toward systems for routing a communication to an appropriate plurality of communication endpoints.

### BACKGROUND

A contact center is often the only interaction a customer has with a particular company. The customer's satisfaction with how an interaction with the contact center is handled is critical to maintaining goodwill and the relationship between the company and the customer. Customers want to be able to reach the contact center quickly and easily and spend a minimal amount of time waiting for their issue to be resolved, preferably by the first person that responds to their call. Strategies, like call-back assist, have been instituted to reduce customer dissatisfaction with waiting in a queue until an agent of the contact center becomes available. However, many customers want or need a solution right away and existing strategies may leave the customer waiting for the best agent for an unacceptably long time.

### SUMMARY

It is with respect to the above issues and other problems that the embodiments presented herein were contemplated. In an ideal situation, a customer contacts an agent of a contact center who has the skills needed to fully address all of the issues that motivated the customer to call. In most contact centers, such a situation is a business impossibility as the benefits would pale in comparison to the costs. However, a positive experience can be provided to the customer if an agent, even one who is less than ideally-skilled or qualified to address all issues, is promptly provided to the customer until an ideally-skilled agent becomes available. If the less than ideally-skilled agent is able to address a portion of the customer's issues, then the customer's experience may be improved, on the one hand, and the contact center operates more efficiently, on the other hand, as the ideally-skilled agent is utilized less for portions of the interaction that can be addressed by the less than ideally-skilled agent. As a benefit, the contact center may have calls on hold for a shorter time and utilize resources more efficiently while providing an improved customer experience.

In one embodiment, systems and methods are provided for temporary or delayed optimal routing of a work item to an endpoint of a sub-skilled agent for subtask processing until an optimal agent becomes available. A work item has at least one subtask, comprising less than the entirety of the work item, which is then routed for handling by a sub-skilled or non-optimal agent. When the optimal agent is available and at least one subtask is completed by the suboptimal agent, the interaction is routed to the optimal agent.

In another embodiment, the preferred routing for a work item is temporarily altered due to a lack of available agents having the optimum skill or skill set. The temporary routing connects the customer associated with the work item to the endpoint of the suboptimal agent when the alternative is an unacceptable wait-time if the work item had proceeded via the preferred routing. In a further embodiment, the optimal agent, or one of a pool of optimal agents, is identified as not presently available to receive a work item and the customer's wait for an optimal agent is above a previously determined acceptable threshold.

If the optimal agent is unavailable and a work item has associated subtasks, a search for a suitable sub-skilled or non-optimal agent may then be conducted. If a sub-skilled agent is available to address at least one subtask (e.g., collect contact and background information), the work item is enqueued for an optimal agent and routed to the sub-skilled agent for processing of the subtask. Once both the subtask is complete and the optimal agent becomes available, the interaction can be routed to the optimal agent. If the optimal agent is not yet available, the work assignment engine can route to a new agent for another subtask handling while the optimal wait continues. While the work item may be routed to another agent (e.g., suboptimal to optimal, first suboptimal to second suboptimal, etc.) routing may be inclusive (e.g., suboptimal then add optimal, first suboptimal then add second suboptimal, etc.).

In an additional embodiment, the system may prompt the suboptimal agent to accept or decline routing to the optimal agent. The optimal agent may receive a notification when the suboptimal agent takes the work item, such as when the suboptimal agent is able, or likely able, to satisfactorily address all subtasks of a work item or when the customer does not wish to be transferred to another agent. In another embodiment, new subtasks may be indentified during the interaction with the customer that cause a different (e.g., additional or alternative) routing to a different next agent (e.g., different optimal agent and/or different subsequent suboptimal agent).

The discovery of subtasks for sub-skilled agents is variously embodied. For example, a specific request for subtasks may be made during a human or automated chat session, a path to route in an interactive voice response (IVR) system, and/or from the context available from a customer resource management (CRM) system, contact history, and/or journey state.

While a customer utilizing a telephone to call a contact center is a more common environment for the embodiments described herein, other forms of real-time communication are also contemplated, including the many forms of real-time or near real-time omni-channel interactions, such as voice/video, text chat, SMS, messaging, etc.

In one example, a voice call and/or a chat interaction occurs between a financial services customer who contacts a mutual fund site (the contact center) to sign up and speak with an advisor. The advisor specialist is not available initially; however, the subtask of taking contact information and creating an account is needed and can be handled by a non-optimal agent. Once the initial task of creating an account is completed, the customer is routed to the waiting advisor.

In other embodiments, the first suboptimal agent stays with the customer and a subsequent suboptimal agent or the optimal agent is brought into the work item via one or more known technologies, such as conferencing, group chat, desktop sharing, etc., provided through agent desktop integrations. While two or more agents may assist a customer serially, wherein a first suboptimal agent processes a subtask and the work item is passed to a second suboptimal agent, or an optimal agent, processes another task, other team-based interactions are also contemplated by the embodiments herein. For example, one agent may assist the customer indirectly, such as via a first agent's whisper mode audio, desktop sharing, etc. The first agent then communicates with the customer on behalf of the second agent to provide a uniform flow of communication along with the expertise of the second agent.

In another example, a customer is requesting service over a mobile chat user interface (UI) for problems encountered while watching streaming movies over an advanced cable service:

1. The customer is validated through automated means either by the mobile app front-ending the chat UI or through automated chat service.

2. The system extracts the topic of the problem through text analysis.

3. The system looks up network state and determines that a connection is not established. From this, the system determines the work item will require agents with skills in connectivity, set top box, and movie navigation UI.

4. The work assignment engine determines that there is no agent available with all these skills, and the expected wait time is 30 minutes.

6. The work assignment engine routing algorithm is temporarily changed once it is determined that there is an agent with connectivity skills and a separate agent with set top box/movie navigation UI skills.

7. The work item is routed to both of these two agents and places them together as a team to respond to the customer. Routing may provide for the agent having the UI skills to be the front agent and the connectivity agent is merged into the chat.

8. The customer and team of agents then interact to resolve the problem. Where connectivity issues are suspected, the connectivity agent provides answers, metered by the UI agent. When set top box/movie UI are tested or worked on, the UI agent covers the interactions.

9. With coordinated effort, the agents discover that there are two problems: (a) a failure on the line, which has been determined to be a cut cable as reported by an on-site technician working on another work item reported as a connectivity failure for all customers in the area, and (b) the customer did not have knowledge of where to initiate the playing of a movie.

10. Once both problems are solved, the agents are released back into the queue for the next work items requiring either individual or team response.

11. In an additional embodiment, upon validation of sub-problem completion, members of the team may be released before the call completes.

In one embodiment, a system is disclosed comprising: a communication interface configured to receive a communication comprising a work item from a customer; a router configured to route the communication to a selected agent of an agent pool; and a processor configured to: determine a plurality of subtasks comprising the work item; identify an optimal agent from the agent pool to process the work item; identify a wait time for the optimal agent; and upon determining the wait time is greater than a previously determined threshold wait time, identify a first subtask from the plurality of subtasks, identify a first suboptimal agent from the agent pool qualified to process the first subtask, signal the router to route the communication to the first suboptimal agent, and enqueue the communication into a queue for the optimal agent.

In another embodiment, a method is disclosed, comprising: receiving a communication comprising a work item from a customer; determining a plurality of subtasks comprising the work item; identifying an optimal agent from the agent pool to process the work item; identifying a wait time for the optimal agent; and upon determining the wait time is greater than a previously determined threshold wait time, identifying a first subtask from the plurality of subtasks, identify a first suboptimal agent from the agent pool qualified to process the first subtask, signal the router to route the communication to the first suboptimal agent, and enqueue the communication into a queue for the optimal agent.

In yet another embodiment, a means for routing a communication to an agent of a contact center is disclosed, comprising: receiving means for the communication comprising a work item from a customer; means for determining a plurality of subtasks comprising the work item; means for identifying an optimal agent from the agent pool to process the work item; means for identifying a wait time for the optimal agent; and upon determining the wait time is greater than a previously determined threshold wait time, means for identifying a first subtask from the plurality of subtasks, means for identify a first suboptimal agent from the agent pool qualified to process the first subtask, means for routing the communication to the first suboptimal agent, and means for enqueuing the communication into a queue for the optimal agent.

It should be appreciated that ordinal designations of the subtasks (e.g., “first subtask,” “second subtask,” etc.) are provided to distinguish one subtask from another and may or may not be associated with any sequential relationship of the subtasks or the order in which subtasks are processed.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed.

However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a communication system in accordance with embodiments of the present disclosure;

FIG. 2 depicts a first communication routing in accordance with embodiments of the present disclosure;

FIG. 3 depicts a second communication routing in accordance with embodiments of the present disclosure;

FIG. 4. depicts a first system in accordance with embodiments of the present disclosure;

FIG. 5. depicts a first process in accordance with embodiments of the present disclosure;

FIG. 6A depicts a first sub-process in accordance with embodiments of the present disclosure;

FIG. 6B depicts a second sub-process in accordance with embodiments of the present disclosure; and

FIG. 6C depicts a third sub-process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

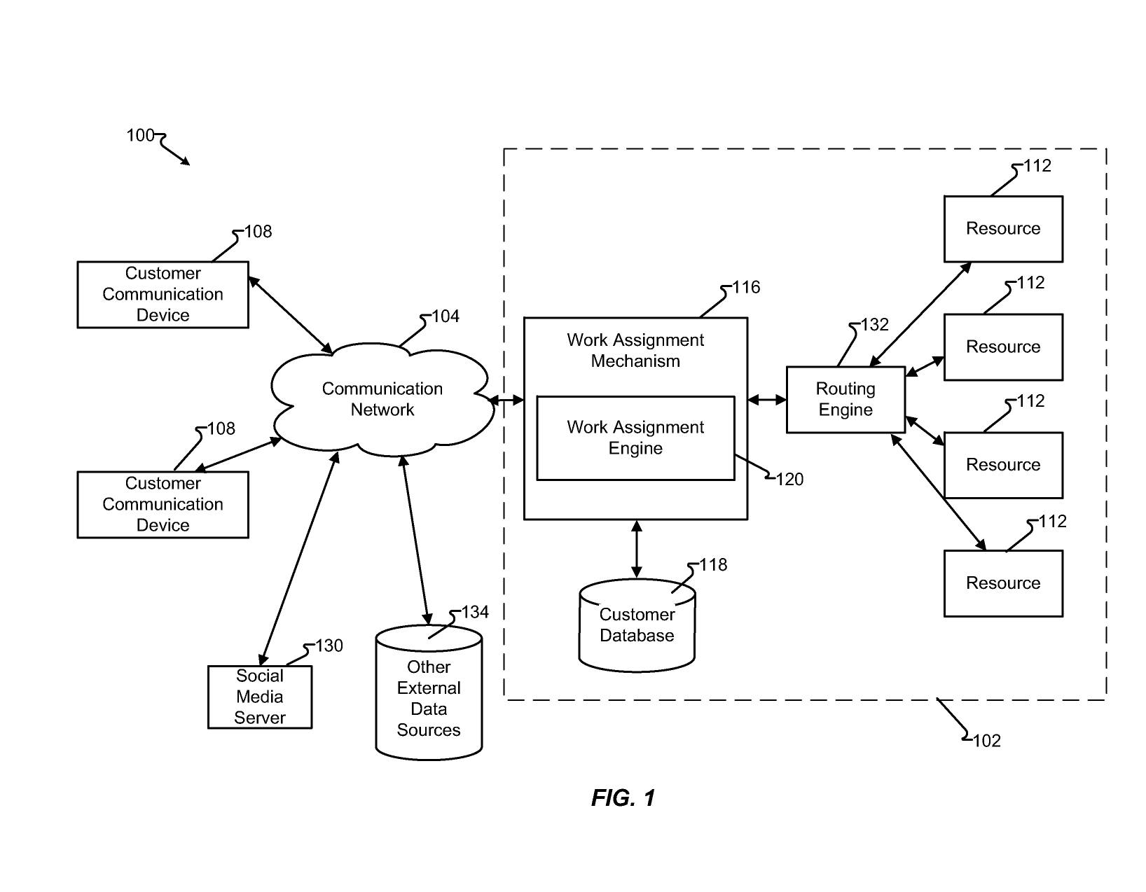

With reference now to FIG. 1, communication system 100 is discussed in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering a contact center 102 in which a plurality of resources 112 are distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102, such as when a customer utilizes customer communication device 108 at a kiosk, which attaches to a private network within or controlled by contact center 102 (e.g., WiFi connection to a kiosk, etc.), and are still considered external to contact center 102.

It should be appreciated that the description of contact center 102 provides at least one embodiment whereby the following embodiments may be more readily understood without limiting such embodiments. Contact center 102 may further be altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources such as service bureaus and third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which is hereby incorporated herein by reference in its entirety.

The format of the work item may depend upon the capabilities of the communication device 108 and the format of the communication. In particular, work items are logical representations within a contact center 102 of work to be performed in connection with servicing a communication received at contact center 102 and, more specifically, the work assignment mechanism 116. The communication may be received and maintained at the work assignment mechanism 116, a switch or server connected to the work assignment mechanism 116, or the like, until a resource 112 is assigned to the work item representing that communication at which point the work assignment mechanism 116 passes the work item to a routing engine 132 to connect the communication device 108, which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices 108 (e.g., human agents utilizing a computer, telephone, laptop, etc.), or any other resource known to be used in contact center 102s.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queue-less contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

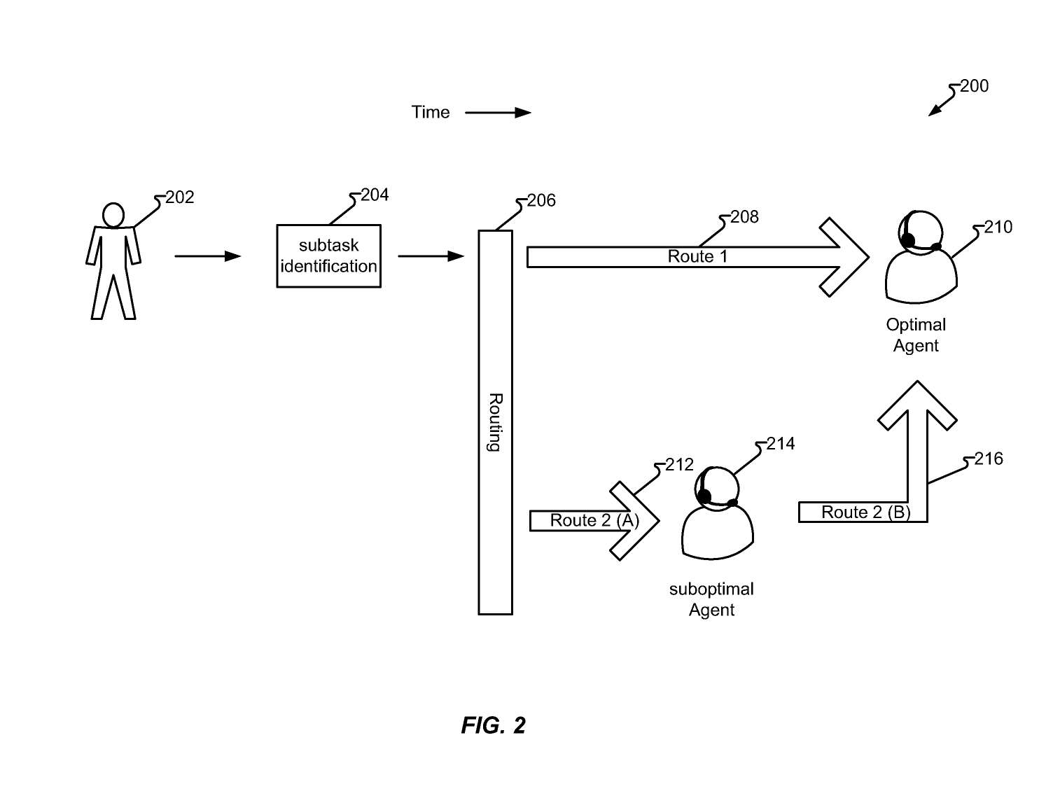

FIG. 2 depicts communication routing 200 in accordance with embodiments of the present disclosure. In one embodiment, customer 202 initiates a work item with contact center 102. Customer 202 may utilize their respective customer communication device 108 to facilitate the communication with contact center 102 and one or more resources 112. The communication comprises the work item, which is further segmented into a plurality of subtasks.

Subtask identification 204 determines the number and skill associated with each of the number of subtasks. In one embodiment, customer 202 interacts with an interactive voice response system to select one or more items. The selected items may comprise the subtasks or may be associated with one or more additional subtasks. In other embodiments, the subtasks are not readily apparent to customer 202 and may be selected as a matter of design choice. For example, customer 202 may be calling to establish a brokerage account. One subtask may be to collect basic information about customer 202 (e.g., name, address, phone number, etc.). Another subtask may be to collect data regarding a funding source (e.g., checking account, savings account, other brokerage account, etc.). Still another subtask may include determining appropriate investments for customer 202, educating customer 202 about various investments, executing an investment purchase, or other aspects associated with an investment account.

Having subtasks identified, routing 206 may select an appropriate agent to interact with customer 202. Based upon subtask identification performed by subtask identification 204, at least one optimal agent 210 may be selected as having the skills associated with the work item and the subtasks identified therein. Optimal agent 210 may be one particular agent or an agent out of the pool of optimal agents. However, the wait time for customer 202 to wait for optimal agent 210 may be unacceptably long. Contact center 102 may determine specific wait times for which an action needs to be taken before customer 202 is likely to drop the call or otherwise be dissatisfied with the experience. If the wait time is below the threshold, the communication is passed via first route leg 208 directly to optimal agent 210 who is then connected with customer 202 immediately or at least in a shorter time then determined by the threshold.

Optimal agent 210 may not be available within the threshold time, however. As such, in another embodiment, at least one subtask is identified that can be handled by a qualified suboptimal agent 214. Accordingly, the communication from customer 202 is routed 206 via a second route leg 212 to suboptimal agent 214. Suboptimal agent 214 is selected in accordance with at least one subtask identified in step 204. In another embodiment, the communication via first route leg 208 is enqueued for optimal agent 210 and, while optimal agent 210 works two items that are enqueued, suboptimal agent 214 is addressing at least one subtask. For example, suboptimal agent 214 may be collecting generic information (e.g., name, address, telephone number, etc.) and simultaneously waiting for optimal agent 210 to be available to accept the communication.

Upon completion of the subtasks, suboptimal agent 214 may signal optimal agent 210 and or a routing means to cause the call to complete the second route leg 216 thereby connecting optimal agent 210 to the communication. In one embodiment, optimal agent 210 joins the communication to both send and receive interactions with customer 202. Optionally, suboptimal agent 214 may disconnect from the communication. In another embodiment, such as when a better customer experience may be provided by maintaining the communication between customer 202 and suboptimal agent 214, optimal agent 210 is entered into a sidebar communication with suboptimal agent 214. The sidebar communication may be a whisper mode, whereby optimal agent 210 is able to speak and be heard only by suboptimal agent 214 and not by customer 202. Other forms of communication may include text, co-browsing, video, or other forms of communication whereby optimal agent 210 may communicate directly to suboptimal agent 214 who then forwards the information received to customer 202 without customer 202's knowledge.

The communication is variously embodied to include real-time communications or near real-time communications, such as voice and video calls, and real-time text exchanges (chat). However, other communication mediums are also contemplated in circumstances wherein a customer's expectation for a reply is limited and not suitable for non-real-time communications (e.g., email, postal mail, etc.).

As a benefit, components of contact center 102 may more efficiently and effectively provide customer service to customer 202 and reduce loads on components of contact center 102. For example, communications enqueued for optimal agent 210 (a human resource 112) are enqueued for a lesser amount of time resulting in fewer switch-based lines being held open and/or fewer packet-switched sessions. Additionally, the content to maintain customer 202 (e.g., music on hold, etc.) in the queue may be simplified or omitted as the wait time before customer 202 reaches an agent, such as suboptimal agent 214, is reduced. For example, customer 202 may be willing to tolerate complete silence on an audio-only call for twenty seconds while waiting to connect to suboptimal agent 214 versus requiring a message or other distraction if the wait time is longer, such as if customer 202 is waiting solely for optimal agent 210.

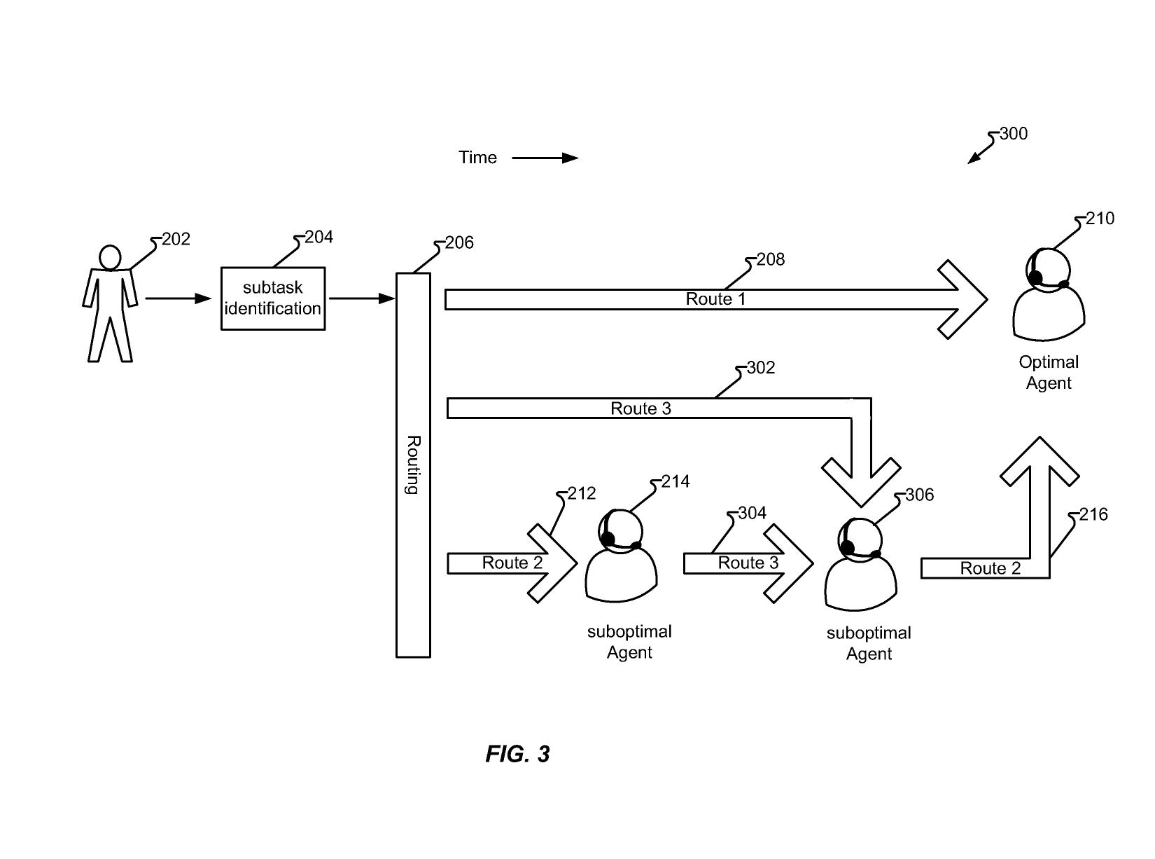

FIG. 3 depicts communication routing 300 in accordance with embodiments of the present disclosure. In one embodiment, communication received by customer 202 progresses to subtask identification 204 wherein the first scenario is identified. In the first scenario, routing 206 is both unable to route the call via a first route leg 208 to optimal agent 210 without requiring an unacceptable wait time for customer 202 and no single suboptimal agent is available to process at least two subtasks. Accordingly, routing 206 routes the communication via second route leg 212 to suboptimal agent 214 and third route leg 302 to suboptimal agent 306. The call to suboptimal agent 306 is enqueued and third route leg 304 joins suboptimal agent 306 to the communication, such as when the communication, enqueued via third route leg 302, is available to be accepted by suboptimal agent 306.

In another embodiment, a second scenario is identified wherein suboptimal agent 214, while processing one subtask, discovers a new subtask requiring suboptimal agent 306. Similarly, the call is routed via third route leg 304 to suboptimal agent 306, which joins the communication when available and/or when the subtasks assigned to suboptimal agent 214 are completed. The call then progresses to optimal agent 210 via second route leg 216.

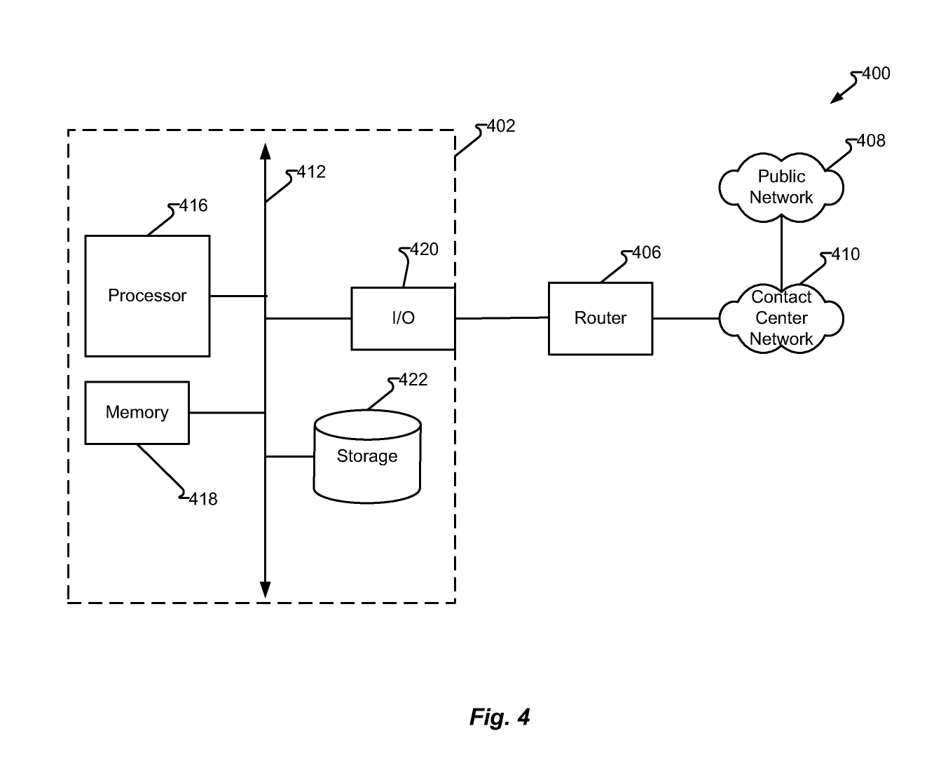

FIG. 4. depicts system 400 in accordance with embodiments of the present disclosure. In one embodiment, server 402 comprises a number of data processing components. For example, server 402 may comprise processor 416, which itself may comprise one or more cores, processing boards, or other data processing hardware. Memory 418 provides accessible memory for processor 416 and/or other components. Data storage is provided by memory 416 and storage 422, which may be an internal and/or external electronic, optical, magnetic, and/or other storage. Input output unit 420 interfaces server 402's external component, such as router 406. In another embodiment, router 406 is co-located within server 402.

A communication received by customer communication device 108 utilizes communication network 104. The communication network 104 may comprise a number of sub-networks, such as public network 408 (e.g., public switched telephone network, Internet, etc.) and private networks, such as contact center network 410, enabling communication between components of contact center 102.

Server 402, upon receiving a communication, accesses a set of skills associated with the pool of agents to identify at least one optimal agent 210 qualified to accept the work item associated with the communication. Upon processor 416 determining that the wait time for optimal agent 210 is unacceptable, selecting at least one suboptimal agent 214 and/or second suboptimal agent 306, qualified to process at least one subtask. Agent skills may be maintained in storage 422 and/or memory 418. Additionally, routing rules utilized by processor 416 may be retrieved from memory 418 and/or storage 422 and communicated such as by bus 412 to input output interface 420. Bus 412 may be a distinct and/or combined data, command, signal bus, such as on a single board or a backplane or other multiple board intercommunication interface.

Upon receiving routing instructions, router 406 signals the appropriate agent, such as suboptimal agent 214 to accept the communication from customer 202 while enqueuing the communication with optimal agent 210. Should additional suboptimal agents be required, processor 416 may signal router 406 to enqueue the communication accordingly until optimal agent 210 becomes available. Or, in another embodiment, suboptimal agent 306 processes all subtasks associated with the work item within the communication.

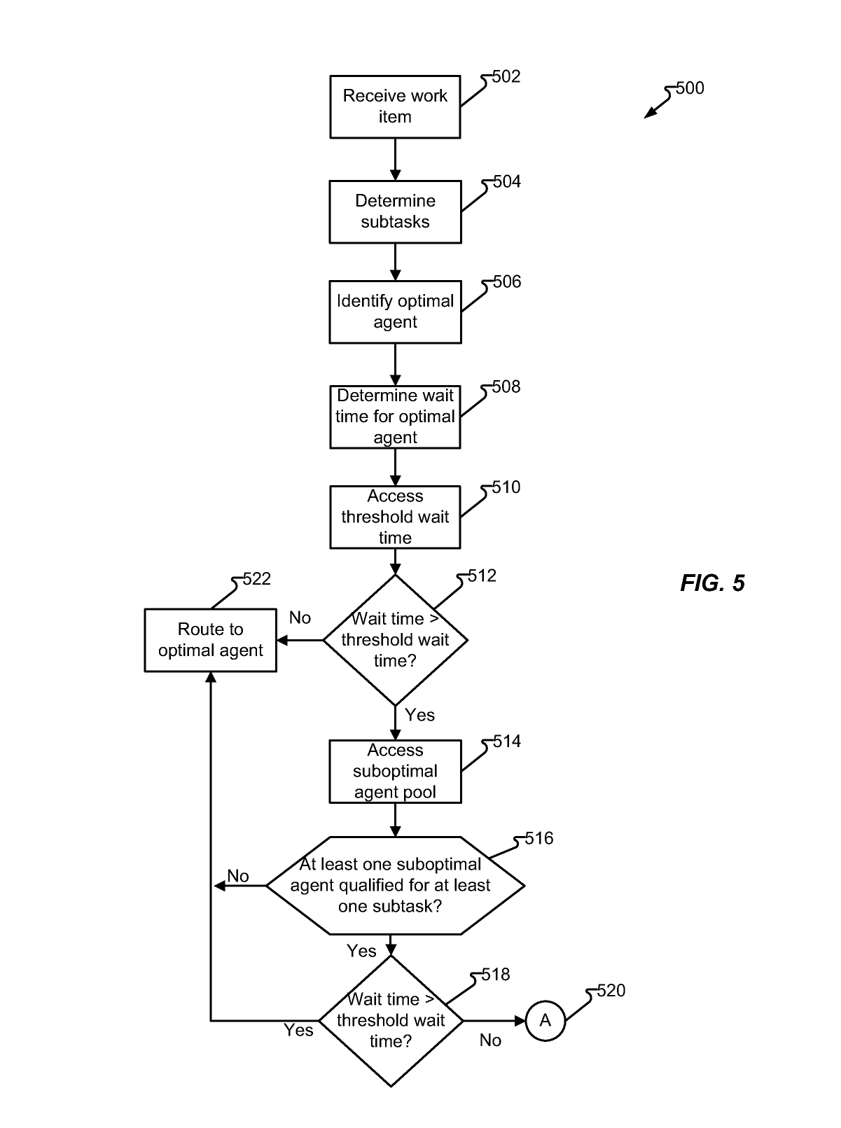

FIG. 5. depicts process 500 in accordance with embodiments of the present disclosure. In one embodiment, process 500 begins at step 502 where the work item is received, such as by a communication from customer 202 received by work assignment mechanism 116 and/or work assignment engine 120. Next, step 504 determines a number of subtasks associated with the work item. Step 506 identifies an optimal agent who can process all subtasks associated with the work item.

Step 508 determines the wait time required for customer 202 to be connected to optimal agent 210. The acceptable wait time threshold is accessed in step 510 and compared in step 512 to determine if the wait time is greater than the threshold wait time. If step 512 is determined in the negative, processing continues to step 522 were in the communication is routed directly to optimal agent 210 selected to process all subtasks associated with the work item. However, if step 512 is determined in the positive, processing continues to step 514 whereby the pool of suboptimal agents is accessed. Step 516 determines if at least one suboptimal agent is qualified to process at least one subtask associated with the work item received in step 502. If step 516 is determined in the negative, processing continues to step 522 whereby customer 202 waits for the optimal agent.

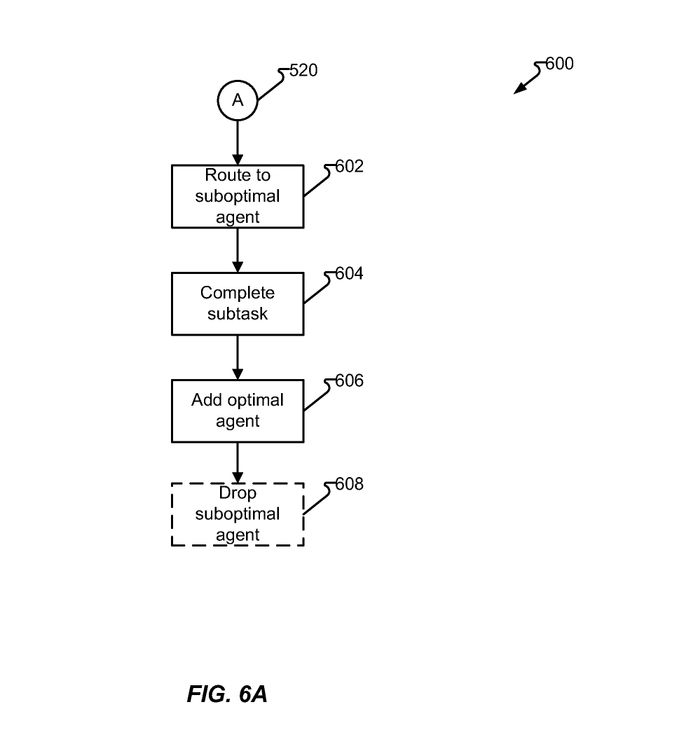

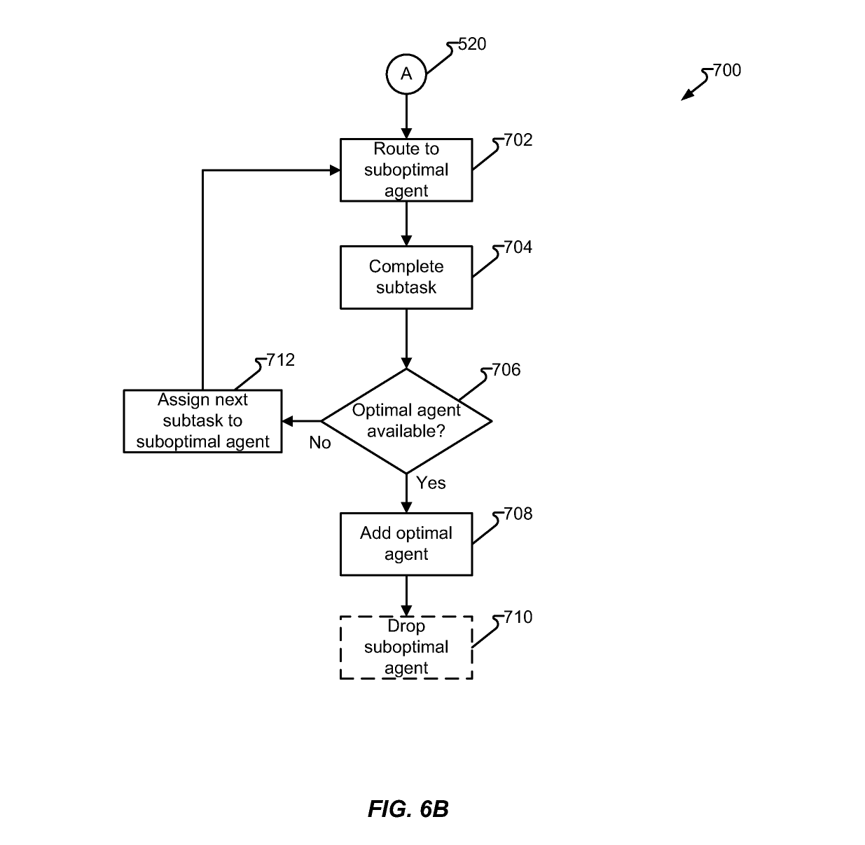

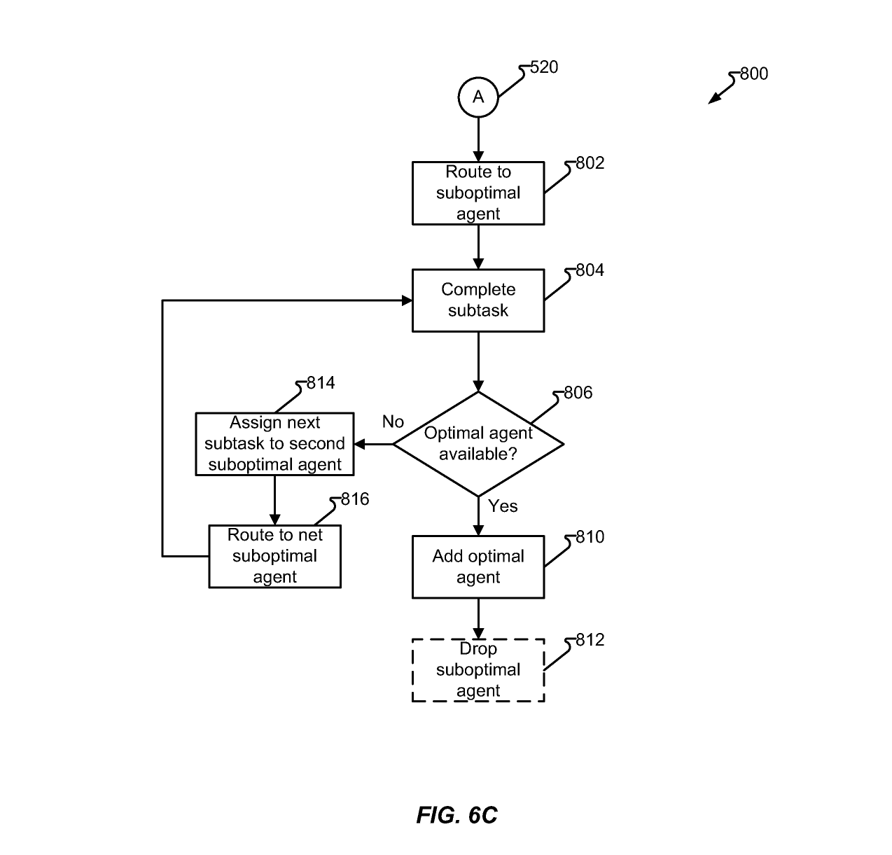

If step 516 is determined in the positive, processing continues to step 518. Step 518 determines if the wait time for a suboptimal agent is greater than a threshold wait time. If step 518 is determined in the positive, the communication is routed to the optimal agent at step 522. The specific wait time may be the same or different for a suboptimal agent versus an optimal agent as a matter of design choice. It may be desirable to have a customer wait longer for an optimal agent as opposed to a shorter wait time for a suboptimal agent, unless the shorter wait time is significant. For example, having a customer wait twelve minutes for a suboptimal agent when an optimal agent is available in thirteen minutes may not be preferred. Instead, the customer is enqueued solely for the optimal agent as the savings in wait time for a suboptimal agent is determined to be of lesser value than connecting the customer to the optimal agent. However, having a customer wait one minute for a suboptimal agent when an optimal agent is not available for ten minutes is more desirable. The specific threshold values may be determined as a matter of design choice and may further accommodate the workload of a contact center or a pool of optimal agents and/or suboptimal agents. If step 518 is determined in the negative, off-page connector 520 resumes the process at least at one of off-page connector 520 for FIGS. 6A, 6B, and 6C.

FIG. 6A depicts first sub-process 600 in accordance with embodiments of the present disclosure. Sub-process 600 continues from off-page connector 520 (see FIG. 5). Step 602 routes the communication to a suboptimal agent. The selected suboptimal agent, such as suboptimal agent 214, processes at least one subtask of the work item and, at step 604, completes the subtask. At step 606, the optimal agent is polled to determine availability or signaled to join the communication, whereby the optimal agent is joined. In another embodiment, step 606 may further comprise re-evaluating the optimal agent pool. A different and/or additional optimal agent may be required, such as due to new facts being revealed during subtask completion step 604 which require an optimal agent with different skills to be assigned to the work item and/or the optimal agent selected in step 506 is not, or will not, become available before a different optimal agent. Accordingly, step 606 may add an optimal agent that is different from the optimal agent selected in step 506.

FIG. 6B depicts second sub-process 700 in accordance with embodiments of the present disclosure. Sub-process 700 continues from off-page connector 520 (see FIG. 5). Step 702 routes the communication to a suboptimal agent, such as suboptimal agent 214. Step 704 provides for the suboptimal agent to complete the subtask assigned and step 706 determines if the optimal agent is available. If step 706 is determined in the affirmative, processing continues to step 708 whereby the optimal agent is added and, optionally, to step 710 whereby the suboptimal agent is dropped from the communication. If step 706 is determined in the negative, step 712 assigns the next subtask to the next suboptimal agent and processing continues at step 702.

In another embodiment, step 706 may further comprise re-evaluating the optimal agent pool to determine if the optimal agent selected in step 506 is available or if a different optimal agent is, or will soon be, available. If a different optimal agent is or will be available, within a previously determined threshold, step 706 may be determined in the affirmative and step 708 adds the different optimal agent. Step 706 may then be determined in the negative if the optimal agent, and no other optimal agents, are yet available.

FIG. 6C depicts third sub-process 800 in accordance with embodiments of the present disclosure. Sub-process 800 continues from off-page connector 520 (see FIG. 5). In one embodiment, step 802 routes the communication to a suboptimal agent who completes a subtask at step 804. Next, step 806 determines if the optimal agent is available. If step 806 is determined in the affirmative, step 810 joins the optimal agent to the communication and, optionally, step 812 drops the suboptimal agent from the communication.

If step 806 is determined in the negative, processing continues to step 814 whereby the next subtask is assigned to a second suboptimal agent 814 and step 816 routes the communication to the second suboptimal agent. The communication may be connected immediately to the second suboptimal agent or enqueued if the suboptimal agent is not yet available. Processing then continues at step 804.

In another embodiment, step 806 may further comprise re-evaluating the optimal agent pool to determine if the optimal agent selected in step 506 is available or if a different optimal agent is, or will soon be, available. If a different optimal agent is or will be available, within a previously determined threshold, step 806 may be determined in the affirmative and step 810 adds the different optimal agent. Step 806 may then be determined in the negative if the optimal agent, and no other optimal agents, are yet available.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a communication interface configured to receive a communication comprising a work item from a customer;
a router configured to route the communication to a selected agent of an agent pool; and
a processor configured to:
determine a plurality of subtasks comprising the work item;
identify an optimal agent from the agent pool to process the work item;
identify a wait time for the optimal agent; and
upon determining the wait time is greater than a previously determined threshold wait time, identify a first subtask from the plurality of subtasks, identify a first suboptimal agent from the agent pool qualified to process the first subtask, signal the router to route the communication to the first suboptimal agent, and enqueue the communication into a queue for the optimal agent.

2. The system of claim 1, wherein the processor is further configured to receive a signal that indicates the first subtask has been completed and the optimal agent is available and, in response to receiving the signal, add the optimal agent to the communication.

3. The system of claim 1, wherein the processor is further configured to:
identify a second suboptimal agent from the agent pool qualified to process a second subtask of the plurality of subtasks; and
signal the router to cause the communication to be joined by the second suboptimal agent.

4. The system of claim 3, wherein the processor is further configured to signal the router to cause the communication to be joined by the second suboptimal agent upon receiving a signal indicating the first subtask is complete without receiving a signal that the optimal agent is available.

5. The system of claim 3, wherein the router is configured to place the second suboptimal agent into a sidebar communication with the first suboptimal agent whereby the customer is excluded from communications from the second suboptimal agent.

6. The system of claim 1, wherein the router is configured to place the optimal agent into a sidebar communication with the first suboptimal agent whereby the customer is excluded from communications from the optimal agent.

7. The system of claim 1, wherein the processor is further configured to receive a signal from the first suboptimal agent indicating a desire to keep the communication and signal the router to de-queue the work item from the queue of the optimal agent.

8. The system of claim 1, wherein the processor is further configured to receive a signal from the first suboptimal agent indicating a newly discovered third subtask and, in response to receiving the signal, identify the second optimal agent to process the work item and the third subtask.

9. The system of claim 8, wherein the processor is further configured to:
identify a wait time for the second optimal agent; and
upon determining the wait time is greater than a previously determined threshold wait time, identify a third suboptimal agent from the agent pool qualified to process the third subtask, and signal the router to enqueue the communication into a queue for the third suboptimal agent.

10. The system of claim 9, wherein the processor is further configured to receive a signal indicating the third suboptimal agent is available and signal the router to connect the third suboptimal agent into the communication configured to allow communications from the third suboptimal agent to be received by at least the first suboptimal agent.

11. A method, comprising:
receiving a communication comprising a work item from a customer;
determining a plurality of subtasks comprising the work item;
identifying an optimal agent from the agent pool to process the work item;
identifying a wait time for the optimal agent; and
upon determining the wait time is greater than a previously determined threshold wait time, identifying a first subtask from the plurality of subtasks, identify a first suboptimal agent from the agent pool qualified to process the first subtask, signal the router to route the communication to the first suboptimal agent, and enqueue the communication into a queue for the optimal agent.

12. The method of claim 11, further comprising receiving a signal that indicates the first subtask has been completed and the optimal agent is available and, in response to receiving the signal, adding the optimal agent to the communication.

13. The method of claim 12, wherein the optimal agent is added to the communication comprising a sidebar communication with the first suboptimal agent whereby the customer is excluded from communications from the optimal agent.

14. The method of claim 11, further comprising:
identifying a second suboptimal agent from the agent pool qualified to process a second subtask of the plurality of subtasks; and
signaling the router to cause the communication to be joined by the second suboptimal agent.

15. The method of claim 14, further comprising signaling the router to cause the communication to be joined by the second suboptimal agent upon receiving a signal indicating the first subtask is complete without receiving a signal that the optimal agent is available.

16. Means for routing a communication to an agent of a contact center, comprising:
receiving means for the communication comprising a work item from a customer;
means for determining a plurality of subtasks comprising the work item;
means for identifying an optimal agent from the agent pool to process the work item;
means for identifying a wait time for the optimal agent; and
upon determining the wait time is greater than a previously determined threshold wait time, means for identifying a first subtask from the plurality of subtasks, means for identifying a first suboptimal agent from the agent pool qualified to process the first subtask, means for routing the communication to the first suboptimal agent, and means for enqueuing the communication into a queue for the optimal agent.

17. The means of claim 16, further comprising, means for determining the first subtask has been completed and the optimal agent is available and, in response, means to add the optimal agent to the communication.

18. The means of claim 17, wherein the optimal agent is added to the communication comprising a side-bar communication with the first suboptimal agent and the customer is unable to receive the communications from the optimal agent.

19. The means of claim 16, further comprising:
means for indentifying a second suboptimal agent from the agent pool qualified to process a second subtask of the plurality of subtasks; and
means for causing the communication to be joined by the second suboptimal agent.

20. The means of claim 19, wherein the second suboptimal agent is added to the communication comprising a side-bar communication with the first suboptimal agent and the customer is unable to receive the communications from the second suboptimal agent.
